(19) United States
(12) Patent Application Publication
(10) Pub. No.: US 2006/0182527 A1
(43) Pub. Date: Aug. 17, 2006

(54) Automated container terminal scheduling

(75) Inventors: Jonathan M. Ranstrom, Moraga, CA (US); Peter J. Ireland, El Cerrito, CA (US); Alexander M. Ozhinsky, Pleasant Hill, CA (US)

Correspondence Address: VAN PELT, YI & JAMES LLP, 10050 N. FOOTHILL BLVD #200, CUPERTINO, CA, 95014, US

(73) Assignee: NAVIS LLC

(21) Appl. No.: 11/093,025

(22) Filed: Mar. 29, 2005

Related U.S. Application Data
(60) Provisional application No. 60/637,130, filed on Dec. 17, 2004.

(51) Int. Cl. B65G 67/60

(52) U.S. Cl. 414/140.3

(57) ABSTRACT

A method for automated container terminal scheduling is disclosed. The method comprises reorganizing a container terminal when resources are available and determining a container carrier plan for each container to be loaded from the container terminal. The method further comprises determining from the container carrier plan a mover schedule for a mover to move a first container to be loaded from the container terminal to a container carrier crane which loads the first container to the container carrier and determining from the mover schedule an individual stack crane schedule which loads the mover with the first container to be loaded from the container terminal.

### CROSS REFERENCE TO OTHER APPLICATIONS

This application claims priority to U.S. Provisional Patent Application No. 60/637,130 (Attorney Docket No. NAVIP003+) entitled EFFICIENT YARD SCHEDULING filed Dec. 17, 2004 which is incorporated herein by reference for all purposes.

### BACKGROUND OF THE INVENTION

An operating marine container terminal poses a complex logistical problem. Ships arrive at the water side. Ship cranes load containers onto the ships and/or unload containers from the ships. Movers move containers from stack cranes to ship cranes and/or from the ship cranes to stack cranes. Stack cranes load containers from the stacks within blocks to the movers and/or unload containers from the movers to the stacks within blocks. Trucks arrive at the land side. Stack cranes load containers from the stacks within blocks to the trucks and/or unload containers from the trucks to the stacks within blocks. In some embodiments, the stack cranes load containers from the stacks within blocks to movers that bring containers to trucks and/or unload containers from movers that got containers from the trucks to the stacks within blocks. Scheduling ship cranes, movers, and stack cranes is either performed by a person or by an automated system.

Marine container terminal scheduling by an automated system is desirable because it is not dependent on key personnel, less expensive, faster, and often better. Automated system scheduling is most efficient when the marine container terminal is organized and when there are no changes to the anticipated ship schedule and marine container terminal operation. However, when there are changes to ship schedule and marine container terminal operation, people are better than automated systems at scheduling the container terminal because people are better at being flexible in their problem solving. Changes that affect scheduling include late ship and/or truck arrivals, custom holds on containers, containers rescheduled for a different ship, a ship docks at different berth, and equipment failure (ship crane, stack crane, or mover). These changes lead to a less organized container terminal and less efficient scheduling. It would be useful if scheduling by an automated system could be flexible and deal with disruptions to maintain an organized container terminal and therefore also maintain its efficiency.

### BRIEF DESCRIPTION OF THE DRAWINGS

Various embodiments of the invention are disclosed in the following detailed description and the accompanying drawings.

FIG. 1 illustrates an embodiment of an automated container terminal.

FIG. 2 illustrates an embodiment of a container terminal automation system.

FIG. 3 illustrates an embodiment of a process for expert decking.

FIG. 4 illustrates an embodiment of a process for prehandling.

FIG. 5 illustrates an embodiment of a process for long shuffle handling.

FIG. 6 illustrates an embodiment of a process for ship planning.

FIG. 7 illustrates an embodiment of a process for mover scheduling.

FIG. 8 illustrates an embodiment of a process for stack crane scheduling.

FIG. 9 illustrates an embodiment of a process for calculating and executing an optimized stack crane schedule.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An automated container terminal scheduler is disclosed. In various embodiments, automated container terminal scheduling includes reorganizing container terminal containers when resources are available and separately optimizing individual crane schedules. In some embodiments, automated container terminal scheduling uses a pull method where ship cranes drive all the other schedules. In some embodiments, the container terminal is not a marine container terminal and the scheduler schedules the loading and unloading of containers from other container carriers including trains, trucks, and/or barges.

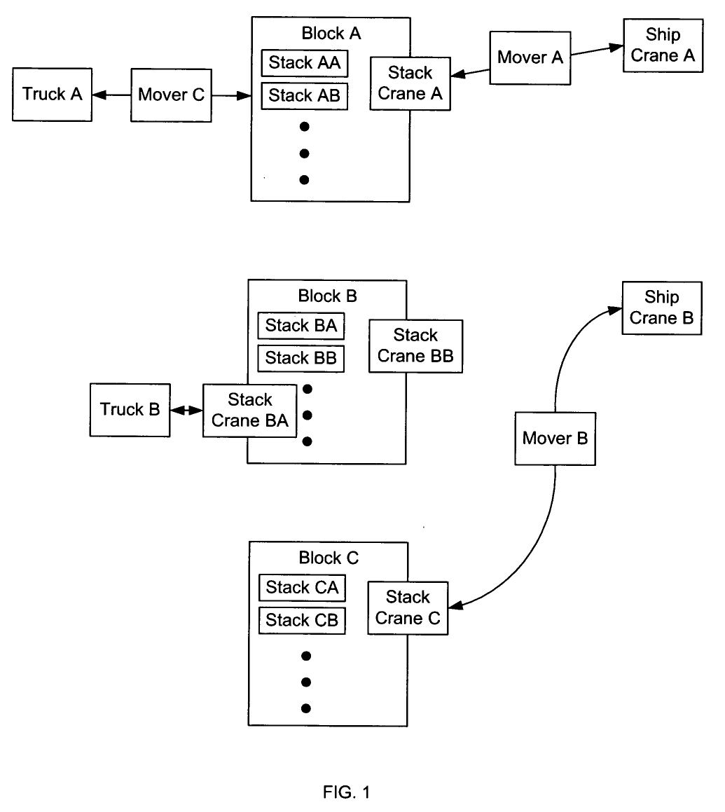

FIG. 1 illustrates an embodiment of an automated container terminal. In the example illustrated, ship crane A loads or unloads ships. Mover A carries containers from stack crane A to ship crane A or to stack crane A from ship crane A. Stack crane A moves containers from a mover into block A, out of block A to a mover, or within block A. Block A contains a plurality of stacks of containers including stack AA and stack AB. In some embodiments, stack crane A moves a container from block A to mover C or from mover C to block A. Mover C moves a container from block A to truck A or to block A from truck A. In some embodiments, the container terminal is not a marine container terminal and a container carrier crane loads or unloads container carriers.

Block B contains a plurality of stacks of containers including stack BA and stack BB. In some embodiments, stack crane BA moves a container from block B to truck B or to block B from truck B. In some embodiments, stack crane BB moves containers within block B and loads containers to and unloads containers from block B. In some embodiments, there are more than two stack crane serving one block. In various embodiments, the stack cranes are automatic, partially manually operated, or fully manually operated. In some embodiments, partially manually operated is where a human operates only the lift and set down of the container and other operations are automatically handled.

In the example illustrated, ship crane B loads or unloads ships. Mover B carries containers from stack crane C to ship crane B or to stack crane C from ship crane B. Stack crane C moves containers from a mover into block C, out of block C to a mover, or within block C. Block C contains a plurality of stacks of containers including stack CA and stack CB. In some embodiments, the container terminal is not a marine container terminal and a container carrier crane loads or unloads container carriers.

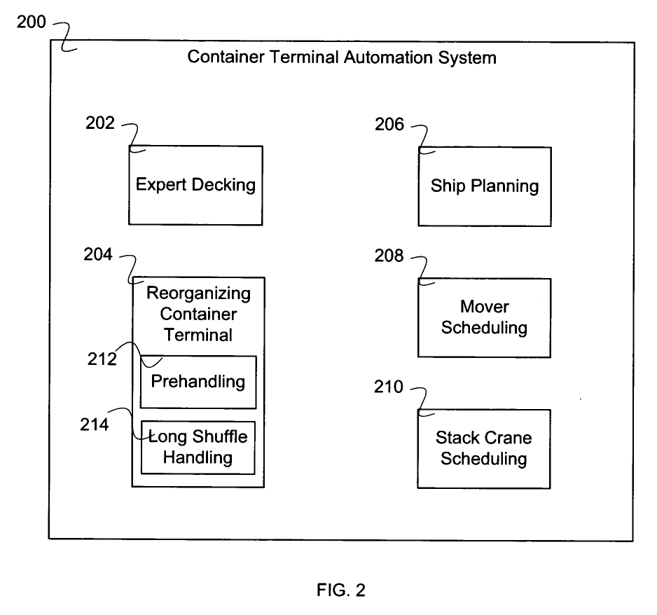

FIG. 2 illustrates an embodiment of a container terminal automation system. In the example illustrated, container terminal automation system 200 includes expert decking 202, reorganizing container terminal 204, ship planning 206, mover scheduling 208, and stack crane scheduling 210. Expert decking 202 determines where a container should be placed in the container terminal. Expert decking 202 is triggered when a container arrives at the container terminal. Reorganizing container terminal 204 includes prehandling 212 and long shuffle handling 214. Reorganizing container terminal occurs when resources are available. In some embodiments, resources are time during which a stack crane is available to move a container within a block. In some embodiments, resources are time when a mover is available to move a container between blocks. Prehandling 212 reorganizes the container terminal by locating containers with a more optimal location and queues those that exceed threshold conditions for being moved. Prehandling 212 runs constantly as a background process. Long shuffle handling 214 reorganizes the container terminal by queuing containers for long moves within the container terminal when there is slack time in mover and stack crane schedules. Long shuffle handling 214 is triggered when the user designates a set of containers for long shuffle handling. Ship planning 206 plans where containers should go on the ship based on where the containers are in the container terminal. Ship planning 206 is triggered before a ship arrives. In some embodiments, the container terminal is not a marine container terminal and container carrier planning plans where containers should go on the container carrier based on where the containers are in the container terminal. Mover scheduling 208 schedules movers to meet the needs of the ship cranes. For loading, mover scheduling 208 arranges for a mover to have the ship-plan required container ready for the ship crane. For unloading, mover scheduling 208 arranges for a mover to have a mover ready to receive a container from the ship crane. Stack crane scheduling 210 schedules loading containers to a block from a mover or truck, loading containers from a block to a mover or truck, and moving containers within a block. Stack crane scheduling 210 is triggered when a mover or truck arrives either requiring unloading or loading a container on the land side or the ship side. In some embodiments, there is an appointment schedule for land side receiving and delivery of containers. In some embodiments there is no appointment schedule.

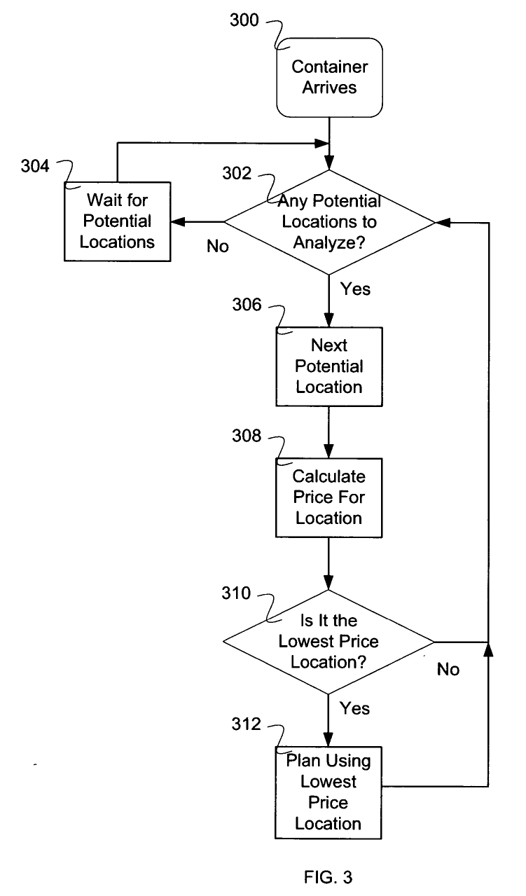

FIG. 3 illustrates an embodiment of a process for expert decking. In the example illustrated, in 300 a container arrives at the marine container terminal. In 302, it is determined if there are any potential locations for the container to analyze. If there are no potential locations for the container, the process waits for potential locations in 304 before returning to 302. If there are potential locations for the container, the next potential location is selected for analysis in 306. In 308, the price for placing the container at the potential location is calculated. The price calculation assigns a value based on how efficient it will be to move the container to anticipated next location (either a ship or truck). For example, a higher price is assigned if the potential location is far from the anticipated next location, and a lower price is assigned if the potential location is near to the anticipated next location. In 310, it is determined if the location is the lowest price location. If it is the lowest price location, then the container is planned for the lowest price location in 312 before returning to 302. If it is not the lowest price location, then the process returns to 302. In some embodiments, the price is lower if moving a first container to a location allows a second container to be more efficiently moved because the second container is being moved from close to the location of where the first container is moved to.

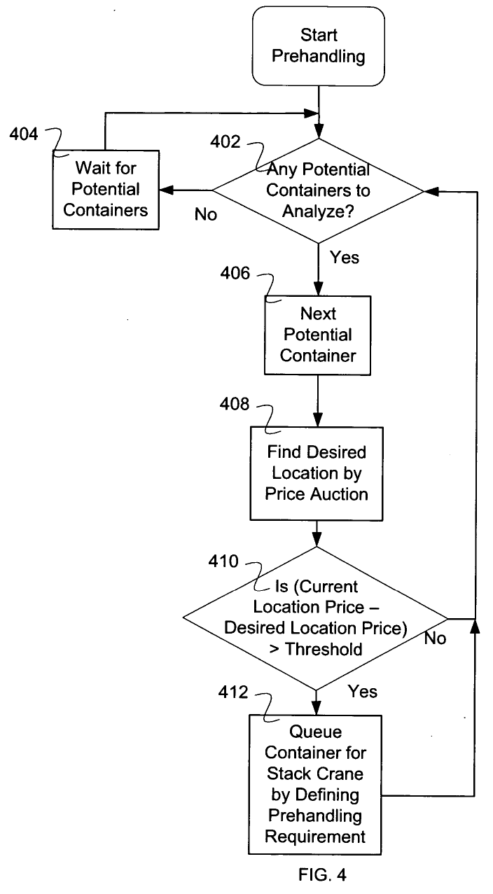

FIG. 4 illustrates an embodiment of a process for prehandling. In the example illustrated, in 402 it is determined if there are any potential containers to analyze. If there are no potential containers to analyze, then the process waits for a potential container to analyze in 404 before returning to 402. If there are potential containers to analyze, then the next potential container is selected for analysis in 406. In 408, the desired location for the container is located by price auction. In 410, it is determined if the current location price minus the desired location price exceeds a threshold. If the threshold is exceeded, then the container is queued for moving by the stack crane to the desired location from the current location in 412 by defining a prehandling requirement to the stack crane schedule. If the threshold is not exceeded then the process returns to 402.

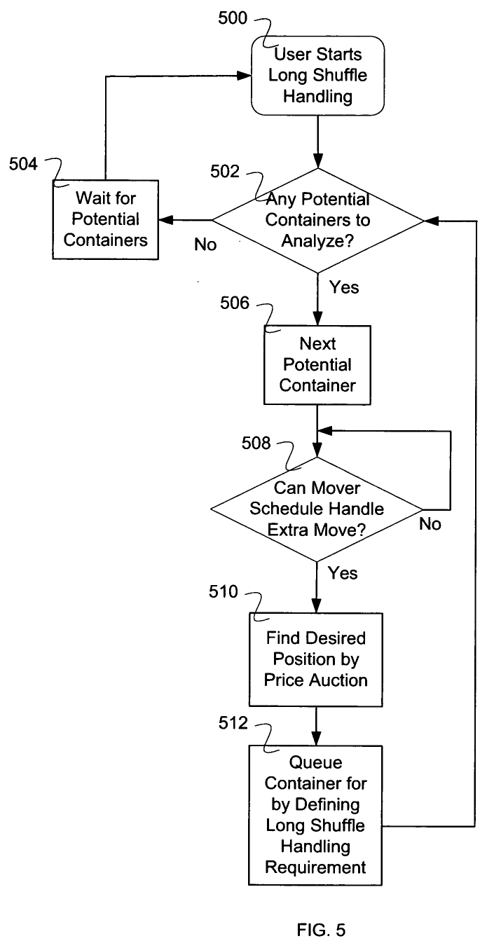

FIG. 5 illustrates an embodiment of a process for long shuffle handling. In the example illustrated, in 500 a user selects containers for long shuffle handling, a move from a current container terminal location to a desired container terminal location. In 502, it is determined if there are any potential containers to analyze for long shuffle handling. If there are not any potential containers to analyze for long shuffle handling, then the process waits for potential containers to analyze in 504. If there are potential containers to analyze for long shuffle handling, then the next potential container to analyze is selected in 506. In 508, it is determined if the mover schedule can handle an extra move. If the mover schedule can not handle an extra move, then the process returns to 508. If the mover schedule can handle an extra move, then the desired position for the container to move to is located by price auction. The price calculation assigns a value based on how close to the desired location the container will be and how available stack crane resources are. For example, a higher price is assigned if the potential location is far from the desired location, and a lower price is assigned if the potential location is near to the desired location. Also, a higher price is assigned if the potential location requires a stack crane that has a very busy schedule, and a lower price is assigned if the potential location requires a stack crane that does not have a very busy schedule. In 512, the container is queued by defining a long shuffle handling requirement for the mover schedule and a long shuffle handling requirement for the appropriate stack crane schedule.

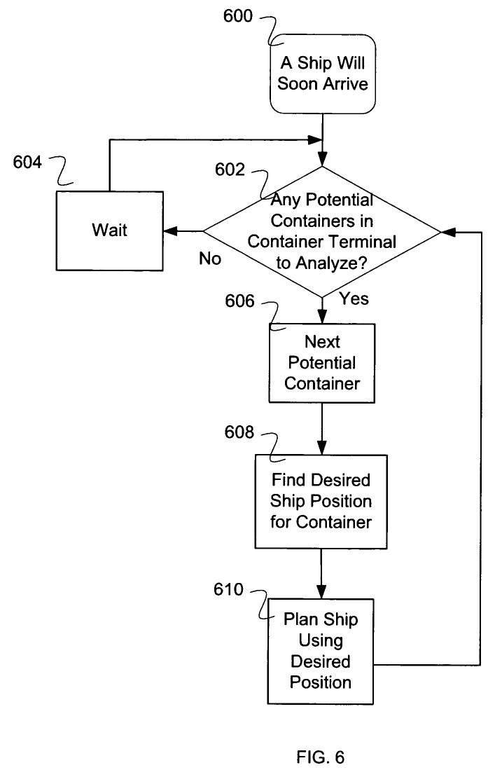

FIG. 6 illustrates an embodiment of a process for ship planning. In the example illustrated, in 600 ship planning is started when it is determined that a ship will soon arrive. In 602, it is determined if there are any potential containers in the container terminal to analyze. If there are not any potential containers in the container terminal to analyze, then in 604 the process waits for another determination that a ship will arrive or for other potential containers to analyze before returning to 602. If there are potential containers in the container terminal to analyze, then in 606 the next potential container to analyze is selected. In 608, the desired ship position for the container is found. In some embodiments, the desired ship position for the container is found using a price auction. In some embodiments, the desired ship position is found using a tree search where subsequent container location prices are dependent on previous container locations. Branches of the tree are searched to locate the lowest price ship plan for specific queued containers and/or projected containers to be loaded. In 610, the ship plan is determined using the desired position for the container before the process returns to 602. In some embodiments, the ship plan is determined manually. In some embodiments, the ship plan is determined partially automatically and partially manually. In some embodiments, the ship plan is found using a genetic algorithm. In some embodiments, the container terminal is not a marine container terminal and the plan is for the loading and/or unloading of containers from other container carriers including trains, trucks, and/or barges.

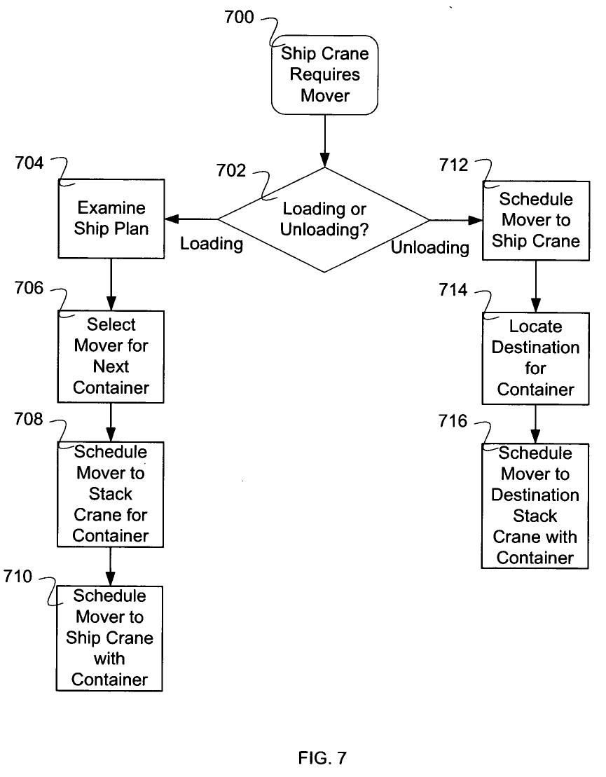

FIG. 7 illustrates an embodiment of a process for mover scheduling. In the example illustrated, in 700 a ship crane requires a mover. In 702, it is determined whether the ship crane is loading a container to the ship or the ship crane is unloading a container from the ship. In some embodiments, the container terminal is not a marine container terminal, and it is determined whether the container carrier crane is loading a container to the container carrier or the container carrier crane is unloading a container from the container carrier. If the ship crane is loading a container to the ship, then in 704 the ship plan is examined. In 706, a mover is selected for moving the next container to the ship crane. In 708, the mover is scheduled to get the next container at a stack crane. In 710, the mover is scheduled to deliver the next container to the ship crane. If the ship crane is unloading a container from the ship, then in 712 a mover is selected and scheduled for moving the container from the ship crane. In 714, a destination is located for the container by expert decking. In 716, the mover is scheduled to deliver next container to the destination stack crane.

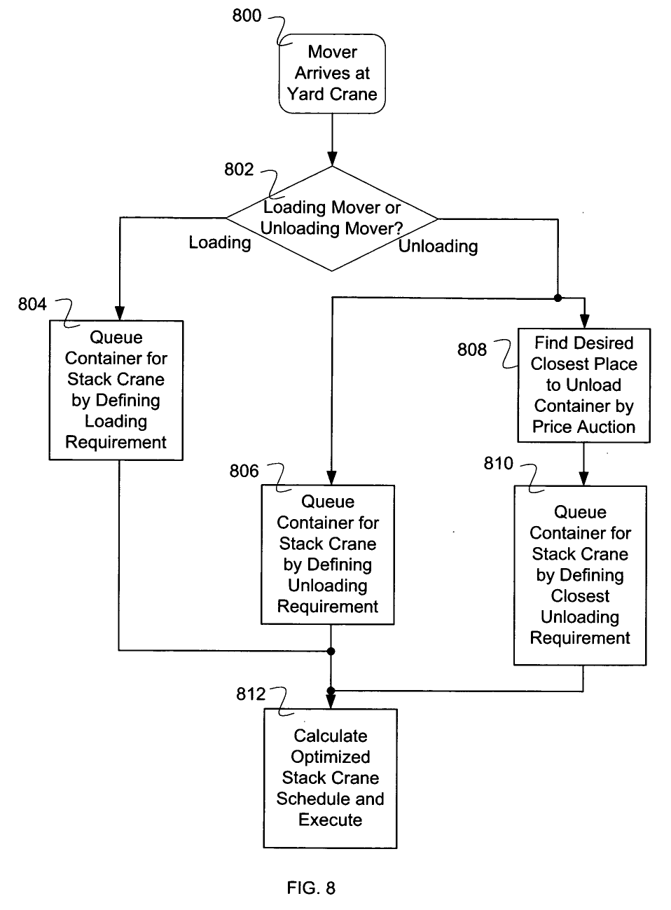

FIG. 8 illustrates an embodiment of a process for stack crane scheduling. In the example illustrated, in 800 a mover arrives at a stack crane. The mover can arrive at the water side or the land side of the block in which the stack crane operates. In some embodiments, a truck arrives at the land side of the block in which the stack crane operates. In 802, it is determined whether the stack crane is loading a container to a mover or unloading a container from a mover. If the stack crane is loading a container to a mover, then in 804 the container is queued for the stack crane by defining a loading requirement. The container to load can be requested by the ship crane whose requests are defined by the ship plan. In some embodiments, the container to load can be requested by the container carrier crane whose requests are defined by the container carrier plan. The container to load can be requested by a land side mover or truck. If the stack crane is unloading a container from a mover, then in 806 the container is queued for the stack crane by defining an unloading requirement. The container to unload can be sent to the stack crane from the ship crane as specified by expert decking. The container to unload can arrive at the stack crane from a land side mover or truck. If the stack crane is unloading a container from a mover, then in 808 a desired closest place to unload the container is found by price auction. In 810, the container is queued for the stack crane by defining a closest unloading requirement. In 812, the optimized stack crane schedule is calculated and executed.

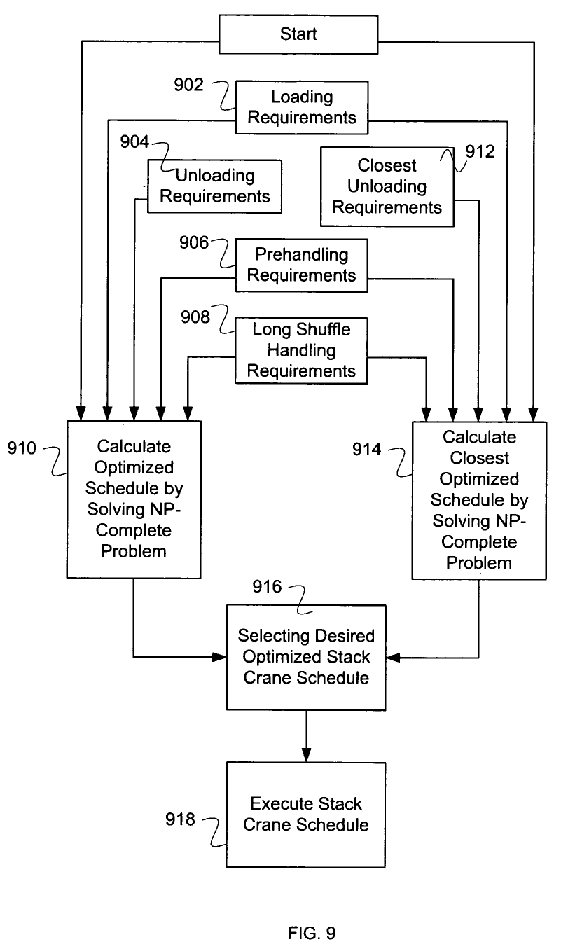

FIG. 9 illustrates an embodiment of a process for calculating and executing an optimized stack crane schedule. In the example illustrated, in 910 an optimized schedule for an individual stack crane is calculated by solving the NP-complete problem of moving containers by the stack crane given the loading requirements 902, unloading requirements 904, the prehandling requirements 906, and the long shuffle handling requirements 908. Loading and unloading requirements can be requirements originating from a mover or a truck. In 914 an optimized schedule is calculated by solving the NP-complete problem of moving containers by the stack crane given the loading requirements 902, closest unloading requirements 914, the prehandling requirements 906, and the long shuffle handling requirements 908. In 916, the desired optimized stack crane schedule for an individual stack crane is selected. In 918, the stack crane schedule is executed. In some embodiments, the NP-complete problem is solved using simulated annealing.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for automated container terminal scheduling comprising:
reorganizing a container terminal when resources are available;
determining a container carrier plan for each container to be loaded from the container terminal;
determining from the container carrier plan a mover schedule for a mover to move a first container to be loaded from the container terminal to a container carrier crane which loads the first container to the container carrier; and
determining from the mover schedule an individual stack crane schedule which loads the mover with the first container to be loaded from the container terminal.

2. A method as recited in claim 1, wherein reorganizing a container terminal includes prehandling.

3. A method as recited in claim 1, wherein reorganizing a container terminal includes prehandling wherein prehandling comprises determining a current location price for a second container, determining a desired location price for the second container, determining that the current location price minus the desired location price exceeds a threshold, and queuing the second container to move to the desired location by defining a requirement to the stack crane schedule.

4. A method as recited in claim 1, wherein reorganizing a container terminal includes long shuffle handling.

5. A method as recited in claim 1, wherein reorganizing a container terminal includes long shuffle handling wherein long shuffle handling comprises determining that the mover schedule can handle an extra move, determining a desired location for a second container, and queuing the second container to move to the desired location for the second container by defining a requirement to the mover schedule and the stack crane schedule.

6. A method as recited in claim 1, wherein reorganizing a container terminal includes long shuffle handling wherein long shuffle handling comprises determining that the mover schedule can handle an extra move, determining a desired location for a second container using a price auction, and queuing the second container to move to the desired location for the second container by defining a requirement to the mover schedule and the stack crane schedule.

7. A method as recited in claim 1, wherein a container carrier plan includes finding a desired container carrier location for the first container.

8. A method as recited in claim 1, wherein a container carrier plan includes finding a desired container carrier location for the first container using a price auction.

9. A method as recited in claim 1, wherein a container carrier plan includes finding a desired container carrier location for the first container using a tree search.

10. A method as recited in claim 1, wherein a container carrier plan is manually planned.

11. A method as recited in claim 1, wherein a container carrier plan is partially manually planned.

12. A method as recited in claim 1, wherein a container carrier plan is planned using a genetic algorithm.

13. A method as recited in claim 1, wherein determining from the mover schedule an individual stack crane schedule comprises solving an NP-complete problem of moving containers by the stack crane given loading requirements and unloading requirements wherein loading and unloading requirements arise from water side and land side requirements.

14. A method as recited in claim 1, wherein determining from the mover schedule an individual stack crane schedule comprises solving an NP-complete problem of moving containers by the stack crane given loading requirements, unloading requirements, prehandling requirements, and long shuffle handling requirements.

15. A method as recited in claim 1, wherein determining from the mover schedule an individual stack crane schedule comprises solving an NP-complete problem of moving containers by the stack crane given loading requirements, unloading requirements, prehandling requirements, and long shuffle handling requirements wherein solving the NP-complete problem uses simulated annealing.

16. A method as recited in claim 1, wherein determining from the mover schedule an individual stack crane schedule comprises solving an NP-complete problem of moving containers by the stack crane in a first stack crane schedule given loading requirements, unloading requirements, prehandling requirements, and long shuffle handling requirements, solving an NP-complete problem of moving containers by the stack crane in a second stack crane schedule given loading requirements, closest unloading requirements, prehandling requirements, and long shuffle handling requirements, and selecting the desired stack crane schedule from the first stack crane schedule and the second stack crane schedule.

17. A method as recited in claim 1, wherein determining from the mover schedule an individual stack crane schedule comprises solving an NP-complete problem of moving containers by the stack crane in a first stack crane schedule given loading requirements, unloading requirements, prehandling requirements, and long shuffle handling requirements, solving an NP-complete problem of moving containers by the stack crane in a second stack crane schedule given loading requirements, closest unloading requirements, prehandling requirements, and long shuffle handling requirements, and selecting the desired stack crane schedule from the first stack crane schedule and the second stack crane schedule wherein solving the NP-complete problem uses simulated annealing.

18. A method for automated container terminal scheduling comprising:
reorganizing a container terminal when resources are available;
determining a first desired location in the container terminal for a first container unloaded from a container carrier using a container carrier crane;
determining a mover schedule for a mover to move the first container from the container carrier crane to a stack crane so that the first container can be put in the first desired location; and
determining an individual stack crane schedule for the first container to be unloaded from the mover and put in the first desired location.

19. A method as recited in claim 18, wherein reorganizing a container terminal includes prehandling.

20. A method as recited in claim 18, wherein reorganizing a container terminal includes prehandling wherein prehandling comprises determining a current location price for a second container, determining a second desired location price for the second container, determining that the current location price minus the second desired location price exceeds a threshold, and queuing the second container to move to the second desired location by defining a requirement to the stack crane schedule.

21. A method as recited in claim 18, wherein reorganizing a container terminal includes long shuffle handling.

22. A method as recited in claim 18, wherein reorganizing a container terminal includes long shuffle handling wherein long shuffle handling comprises determining that the mover schedule can handle an extra move, determining a second desired location for a second container using a price auction, and queuing the second container to move to the second desired location for the second container by defining a requirement to the mover schedule and the stack crane schedule.

23. A method as recited in claim 18, wherein determining a first desired container terminal location uses a price auction.

24. A method as recited in claim 18, wherein determining a first desired container terminal location uses a price auction wherein the price is lower when moving the first container to a first location allows a second container to be more efficiently moved because the second container is being moved from a second location that is close to the first location.

25. A method as recited in claim 18, wherein determining an individual stack crane schedule includes determining a first optimal schedule for the first desired location, determining a second optimal schedule for a second desired location which is closer than the first desired location, and selecting a desired optimal schedule from between the first optimal schedule and the second optimal schedule.

26. A method as recited in claim 18, wherein determining an individual stack crane schedule includes determining a first optimal schedule for the first desired location, determining a second optimal schedule for a second desired location which is closer than the first desired location, and selecting a desired optimal schedule from between the first optimal schedule and the second optimal schedule wherein the first optimal and second optimal schedule are determined using simulated annealing.

27. A method as recited in claim 18, wherein determining an individual stack crane schedule comprises solving an NP-complete problem of moving containers by the stack crane given loading requirements and unloading requirements wherein loading and unloading requirements arise from water side and land side requirements.

28. A method as recited in claim 18, wherein determining an individual stack crane schedule comprises solving an NP-complete problem of moving containers by the stack crane given loading requirements, unloading requirements, prehandling requirements, and long shuffle handling requirements.

29. A method as recited in claim 18, wherein determining an individual stack crane schedule comprises solving an NP-complete problem of moving containers by the stack crane given loading requirements, unloading requirements, prehandling requirements, and long shuffle handling requirements wherein solving the NP-complete problem uses simulated annealing.

30. A method as recited in claim 18, wherein determining an individual stack crane schedule comprises solving an NP-complete problem of moving containers by the stack crane in a first stack crane schedule given loading requirements, unloading requirements, prehandling requirements, and long shuffle handling requirements, solving an NP-complete problem of moving containers by the stack crane in a second stack crane schedule given loading requirements, closest unloading requirements, prehandling requirements, and long shuffle handling requirements, and selecting the desired stack crane schedule from the first stack crane schedule and the second stack crane schedule.

31. A method as recited in claim 18, wherein determining an individual stack crane schedule comprises solving an NP-complete problem of moving containers by the stack crane in a first stack crane schedule given loading requirements, unloading requirements, prehandling requirements, and long shuffle handling requirements, solving an NP-complete problem of moving containers by the stack crane in a second stack crane schedule given loading requirements, closest unloading requirements, prehandling requirements, and long shuffle handling requirements, and selecting the desired stack crane schedule from the first stack crane schedule and the second stack crane schedule wherein solving the NP-complete problem uses simulated annealing.

32. A computer program product for automated container terminal scheduling, the computer program product being embodied in a computer readable medium and comprising computer instructions for:
reorganizing a container terminal when resources are available;
determining a container carrier plan for each container to be loaded from the container terminal;
determining from the container carrier plan a mover schedule for a mover to move a first container to be loaded from the container terminal to a container carrier crane which loads the container to the container carrier; and
determining from the mover schedule an individual stack crane schedule which loads the mover with the first container to be loaded from the container terminal.

33. A computer program product for automated container terminal scheduling, the computer program product being embodied in a computer readable medium and comprising computer instructions for:
reorganizing a container terminal when resources are available;
determining a first desired location in the container terminal for a first container unloaded from a container carrier using a container carrier crane;
determining a mover schedule for a mover to move the first container from the container carrier crane to a stack crane so that the first container can be put in the first desired location; and
determining an individual stack crane schedule for the first container to be unloaded from the mover and put in the first desired location.

34. A system for automated container terminal scheduling comprising:
a processor for reorganizing a container terminal when resources are available;
a processor for determining a container carrier plan for each container to be loaded from the container terminal;
a processor for determining from the container carrier plan a mover schedule for a mover to move a first container to be loaded from the container terminal to a container carrier crane which loads the container to the container carrier; and
a processor for determining from the mover schedule an individual stack crane schedule which loads the mover with the first container to be loaded from the container terminal.

35. A system for automated container terminal scheduling comprising:
a processor for reorganizing a container terminal when resources are available;
a processor for determining a first desired location in the container terminal for a first container unloaded from a container carrier using a container carrier crane;
a processor for determining a mover schedule for a mover to move the first container from the container carrier crane to a stack crane so that the first container can be put in the first desired location; and
a processor for determining an individual stack crane schedule for the first container to be unloaded from the mover and put in the first desired location.

36. A method for prehandling during automated container terminal scheduling comprising:
determining a current location price for a container;
determining a desired location price for the container;
determining if the current location price minus the desired location price exceeds a threshold; and
queuing the container to move to the desired location by defining a requirement to a stack crane schedule if the threshold is exceeded.

37. A method for long shuffle handling during automated container terminal scheduling comprising:
determining if a mover schedule can handle an extra move;
determining a desired location for the container if the mover schedule can handle an extra move; and
queuing the container to move to the desired location for the container by defining a requirement to the mover schedule and a stack crane schedule.

38. A method as recited in claim 36, wherein determining a desired location for the container uses a price auction.

39. A computer program product for prehandling during automated container terminal scheduling, the computer program product being embodied in a computer readable medium and comprising computer instructions for:
determining a current location price for a container;
determining a desired location price for the container;
determining if the current location price minus the desired location price exceeds a threshold; and
queuing the container to move to the desired location by defining a requirement to a stack crane schedule if the threshold is exceeded.

40. A computer program product for long shuffle handling during automated container terminal scheduling, the computer program product being embodied in a computer readable medium and comprising computer instructions for:
determining if a mover schedule can handle an extra move;
determining a desired location for the container if the mover schedule can handle an extra move; and
queuing the container to move to the desired location for the container by defining a requirement to the mover schedule and a stack crane schedule.

41. A computer program product as recited in claim 39, wherein determining a desired location for the container uses a price auction.

42. A system for prehandling during automated container terminal scheduling comprising:
a processor for determining a current location price for a container;
a processor for determining a desired location price for the container;
a processor for determining if the current location price minus the desired location price exceeds a threshold; and
a processor for queuing the container to move to the desired location by defining a requirement to a stack crane schedule if the threshold is exceeded.

43. A system for long shuffle handling during automated container terminal scheduling comprising:
a processor for determining if a mover schedule can handle an extra move;
a processor for determining a desired location for the container if the mover schedule can handle an extra move; and
a processor for queuing the container to move to the desired location for the container by defining a requirement to the mover schedule and a stack crane schedule.

44. A system as recited in claim 42, wherein determining a desired location for the container uses a price auction.
